(19) United States
(12) Patent Application Publication
(10) Pub. No.: US 2006/0290223 A1
(43) Pub. Date: Dec. 28, 2006

(54) External rotor drive

(76) Inventors: Daniel Burri, Konolfingen (CH); Martin Frohlich, Koniz (CH)

Correspondence Address: RATNERPRESTIA, P O BOX 980, VALLEY FORGE, PA, 19482-0980, US

(21) Appl. No.: 10/574,332

(22) PCT Filed: Dec. 3, 2004
(86) PCT No.: PCT/EP04/13784

§ 371 Date: Mar. 31, 2006

(30) Foreign Application Priority Data
Dec. 12, 2003 (DE) 103582932

(51) Int. Cl. H02K 1/00; H02K 1/22

(52) U.S. Cl. 310/179; 310/261

(57) ABSTRACT

A rotary body for a printing press, comprising a stator and a rotor, which can be rotated in relation to the stator and equipped with at least one permanent magnet. At least one stator winding is provided in the stator in such a way that a torque, which acts on the rotor, can be generated by the interaction of said winding with the at least one permanent magnet of the rotor. A drive for a printing press, comprising a rotary body of this type, is also provided.

This application is the U.S. national phase application of PCT International Application No. PCT/EP2004/013784, filed Dec. 3, 2004, and claims priority to German Patent Application No. 103 58 293.2, filed on Dec. 12, 2003.

### FIELD OF THE INVENTION

The present invention relates to a rotary-driven rotation body for a printing machine and to a printing machine drive which uses such a rotation body.

### BACKGROUND OF THE INVENTION

Transfer cylinders of a printing machine, such as for example printing cylinders, are commonly driven by a motor which is for example connected to the transfer cylinder via a gearing mechanism.

A transfer cylinder is known from DE 195 30 283 A1, comprising an integrated external rotor motor, wherein the rotor is formed by a hollow part of the transfer cylinder, on the inner side of which magnets are mounted.

### SUMMARY OF THE INVENTION

It is an object of the invention to suggest a rotary-driven rotation body and a printing machine drive which are suitable for driving one or more of any rotation bodies or cylinders of a printing machine with a sufficiently large torque.

A rotation body in accordance with the invention comprises an electromotive external rotor drive, wherein a shell or cylinder element is designed as a rotor and is for example hollow on the inside or comprises a blind hole and, in at least a partial area and preferably approximately over the whole area of the longitudinal axis, comprises one or more magnetic elements on its inner side, in particular permanent magnets which can for example consist of a rare earth metal and generate a magnetic field in the interior of the rotation body or cylinder, in order for example to serve as a permanent activator for an alternating-current motor or rotary-current motor. The cylinder or rotor connected to the permanent magnet is pivoted on or relative to a stator which is located in at least a partial area of the cylinder or rotor, preferably in its interior, and preferably extends along approximately the entire longitudinal axis of the cylinder. Thus, in accordance with one embodiment, the stator can be provided in a blind hole of the cylinder or can also extend through the entire cylinder, wherein in this case, the cylinder only consists for example of a shell connected to permanent magnets. At least one conduit or magnetic coil is arranged in the stator such that, when a current flows through the conduit or magnetic coil, a torque acts on the rotor or cylinder pivoted relative to the stator and can for example drive, accelerate or also decelerate the cylinder.

In principle, the invention can be used in individual rotation bodies or all the rotation bodies of a printing machine which are to be driven, such as for example in one or more central cylinders or steel cylinders, printing blanket cylinders, form cylinders or plate cylinders, rubber cylinders, knife cylinders, collecting cylinders and/or cutting cylinders, inking rollers and/or dampening rollers and/or in the folding apparatus. In particular, for example once the rotation body surface has been correspondingly coated or machined, the rotation body itself can for example form one of the cited cylinders or rollers of the printing machine or can serve as a bearing or support for the same, wherein for example a cylindrical roller body is slid onto and for example fixed on the rotation body.

The stator preferably comprises at least one electrical conduit, in particular one or more magnetic coils or windings which are arranged such that, when a current flows through the conduits or windings, a torque is generated on the rotor connected to permanent magnets. External rotor motors and the arrangement of stator windings are known in the prior art. Reference is made for example to DE 102 13 743 A1, the technical teaching of which with respect to the construction of an external rotor motor is incorporated into this application. In accordance with the invention, one or more stator windings can be provided along the axial direction of the stator, such that over a partial area, for example half the length of the rotor, or over a larger area, preferably over the entire length of the rotor, a magnetic field for driving the rotor can be generated, wherein the stator windings can be provided as windings on the outer surface of the stator, such that they act as electromagnets which co-operate for example with permanent magnets in or on an inner surface of the rotor or rotor casing, in order to be able to generate an accelerating or decelerating force which influences the rotation of the rotor.

As described above, the rotor or cylinder can be pivoted or mounted on the stator either directly or for example via one or more ball bearings.

It is also possible for the rotor to not be directly mounted to the stator, but to be attached to an external wall or housing, for example to the side wall of a printing machine, such that it is pivoted. The rotor can also for example be connected on one side to the stator via a ball bearing and on an opposing side to an external retainer, such as for example a side wall of a printing machine, via a ball bearing.

It is also possible for the stator to be connected in a non-positive and/or positive lock to a retainer, such as for example a printing frame wall. In accordance with the invention, a prefabricated roller motor, in particular an external rotor motor, can thus be used to drive printing machine rollers and/or cylinders, wherein the motor can for example be completely prefabricated, i.e. can comprise the rotor and the stator, wherein the rotor casing comprises permanent magnets on its inner surface and the stator comprises windings as electromagnets on its outer surface. The rotor casing can exhibit an outer diameter or a profile which for example corresponds to the recess or the inner diameter or profile in a printing cylinder or in a roller, wherein in order to achieve a good frictional lock between the rotor casing and the printing cylinder or roller, the interlocking surfaces can preferably be designed slightly conical. The external rotor outer surface can for example be designed conical.

Advantageously, the length of the stator measures such that it does not extend beyond the partition wall measurement of the bearing locations or bearing walls which are reciprocally distanced in parallel, in particular the printing frame walls.

Printing unit cylinders and/or rollers can thus be simply fitted with or dismantled from a pre-fitted external rotor motor between printing unit walls distanced in parallel. Various printing format sections can also be combined into one motor output range, for example by designing the rotor casing diameter with different measurements.

In accordance with the invention, the rotation body consisting of the stator and the rotor can be designed as a magnetically sealed system and can thus have little external magnetic effect, such that magnetic effects on neighbouring metallic objects are prevented, wherein the wall thickness on a printing unit cylinder or printing unit roller can for example be selected such that the rotation body or the motor is magnetically sealed.

A cooling unit is preferably provided on the stator and particularly preferably connected to the stator or in the stator. A cooling medium, such as for example a cooling fluid, in particular cooling water, can for example be channelled through a partial area or also through the entire stator, i.e. for example over the entire length of the stator, in order for example to be able to channel away waste heat arising in the stator from the stator windings. Other cooling elements or cooling mechanisms can likewise be used, such as for example cooling an outer or peripheral area of the stator, which can also sufficiently cool areas or components of the stator if the stator is made from a heat-conductive material, such as for example iron.

Heated components, such as for example a stator winding, can additionally or alternatively be cooled by a current of air channelled over them. A current of air can also advantageously be generated by rotating the cylinder or rotor, wherein elements or flywheels are for example attached on the inner side of the rotor and can generate a current of air approximately in the axial direction when the rotor is rotated.

Attaching conduits for current and/or a cooling medium in the stator is relatively simple, since the stator does not move relative to its attachment location and thus sliding contacts or the like can for example be omitted.

The electrical conduits or magnetic coils, used as stator windings, and/or a cooling system, i.e. for example conduits for a cooling medium, particularly preferably extend approximately over the entire length of the stator, wherein a number of stator windings can for example be provided, distributed from a first end up to a second end of the stator, axially distanced. This enables the rotor or cylinder to be driven over the entire length of the rotor or stator, which are advantageously of approximately equal length, such that a larger torque and/or driving force can be generated as compared to a drive which is only provided in a partial area of the rotor.

The magnetic element or elements connected to the rotor are preferably provided in the area of or on the inner side of the rotor and can for example be designed annular, wherein a number of magnetic rings can for example be provided on the inner side along the axial direction of the cylinder, each exhibiting a predefined distance from each other. It is likewise also possible for individual separate magnets to be provided on the inner side of the rotor, which are constructed such that a magnetic field necessary to actuate an external rotor motor is generated. It is also possible for the magnets to be designed as rods or for a combination of individual magnets, annular magnets or rod magnets.

The rotation body in accordance with the invention can for example be used in conjunction with or also as a rubber blanket cylinder, a plate cylinder, a deflecting cylinder, a drawing roller, a ductor or a reel changer.

The invention relates not only to the combination of a rotor as described above with a stator as described above, but also to such a rotor or such a stator in its own right, not in conjunction with the other element in each case.

The invention thus enables rollers to be made comprising idle shaft journals, significantly simplifying assembling and disassembling rollers. The drive of such a roller is likewise advantageous, since the roller shell can have a smaller mass and thus a smaller inertial mass relative to a roller which is designed solid.

In accordance with another aspect, the invention relates to a printing machine drive which uses such a rotation body.

In such a printing machine drive, a control device is preferably provided for controlling the current flowing in conduits or windings of the rotor. The control device can for example control the frequency, the voltage and/or the strength of the current, in order for example to thus regulate the speed of the rotor and to accelerate, synchronise or decelerate the rotor in accordance with predefined printing states or printing conditions.

A sensor can preferably be provided which detects an angular position of the rotor, in order for example to form a regulating circuit in conjunction with a control device as described above, wherein for controlling the synchronisation of a number of printing cylinders with respect to each other, individual angular positions of various rotors are also detected and the control of the stator windings is controlled or regulated in accordance with the detected angular positions and, as applicable, in accordance with predefined target values, such that for example a frequency, voltage and/or strength of the current is applied to the stator windings in order to stop or restart the synchronisation of a number of printing cylinders.

The rotation body rotary-driven in accordance with the invention is particularly preferably used as a driving motor of a cylinder grouping consisting of a mechanically coupled plate cylinder and a rubber blanket cylinder. In particular, the rotation body in accordance with the invention is used as a rubber blanket cylinder or as a plate cylinder in such a paired drive, wherein at least one rotation body in accordance with the invention is provided in such a cylinder grouping, and a number of cylinder groupings are preferably driven by a number of such rotation bodies. Reference is made to EP 0 644 048 belonging to the applicant, the technical teaching of which with respect to forming cylinder groupings in pairs using a rubber blanket cylinder and a plate cylinder of a rotation machine and jointly driving such a cylinder grouping using a separate driving motor per cylinder grouping, and with respect to the use of toothed belts and the general construction of printing machine drives, is incorporated into this application. Using a rotary-driven rotation body in accordance with the invention, a separate motor for driving a rubber blanket cylinder or a plate cylinder coupled to it can thus be omitted in the arrangement described in EP 0 644 048, since the rubber blanket cylinder or the plate cylinder themselves are designed as a rotary-driven rotation body in accordance with the invention.

### BRIEF DESCRIPTION OF THE DRAWINGS

FIG. 1 is a cross-sectional view of a rotation body comprising two variants of an external rotor drive;

FIG. 2 is a cross-sectional view of an example embodiment of an axially movable external rotor motor;

FIG. 3 is a cross-sectional view of an embodiment of an axially immovable external rotor motor; and

FIGS. 4a and 4b are schematic diagrams of rollers or cylinders which are driven by one or two rotation bodies in accordance with the invention.

### DETAILED DESCRIPTION OF THE PREFERRED EMBODIMENTS

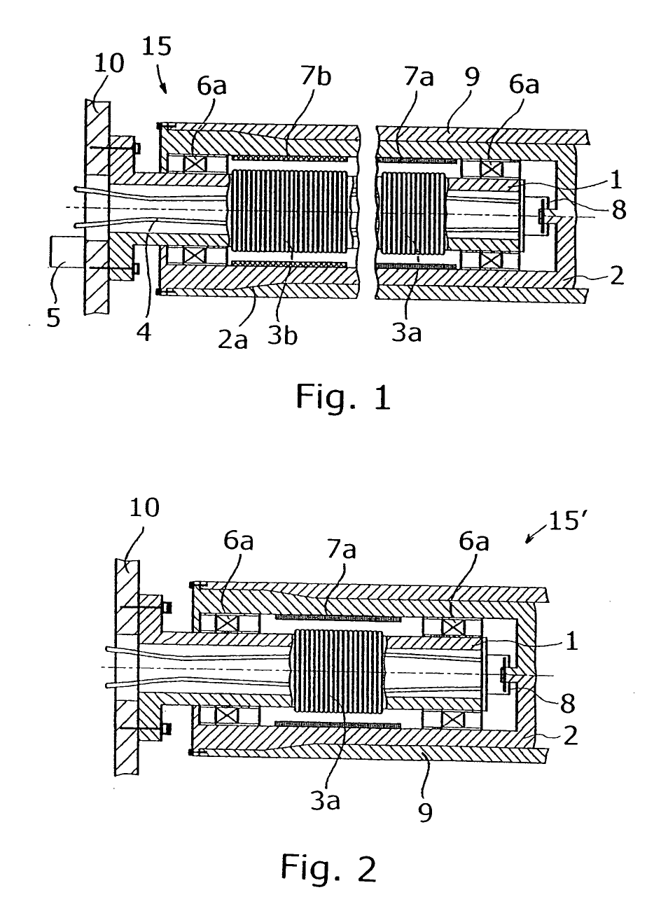

FIG. 1 shows a rotation body 15 including a stator 1 of a roller body or plate cylinder 9, in each case laterally fixed and not pivoted in a retainer 10. The retainer 10 can for example be the outer wall of a printing machine. Stator windings 3a, 3b and a circuit 4 for a cooling medium are provided in the interior of the stator 1 in order to be able to channel away waste heat arising in the stator 1, for example from a flow of current through the stator windings 3a, 3b. The stator windings 3a, 3b are connected via a three-phase motor cable to a frequency control unit 5 which is provided outside the stator 1 and preferably outside the printing machine, for example on the outer wall 10 of the printing machine.

On the circumferential side of the stator 1, a ball bearing 6a which is preferably axially movable is provided on each end of the stator 1, the rotor 2 being supported on said ball bearing 6a such that the rotor 2 can rotate relative to the stator 1. In the two embodiments shown, permanent magnets 7a, 7b are attached to the inner side of the rotor 2 and generate a magnetic field necessary for an external rotor motor. In the embodiment shown, the rotor 2 is used as a plate cylinder, with a roller body 9 which is placed or slid onto the rotor and held in a non-positive, frictional or positive lock by a conical or truncated conical area 2a of the rotor 2.

Alongside the plate cylinder shown by way of example in FIG. 1, a rubber blanket cylinder can be arranged which is either mechanically coupled to the plate cylinder and thus driven by it, or which can likewise be designed as a rotary-driven rotation body comprising the elements 1 to 7 of the plate cylinder as described above, with a rubber blanket cylinder 9 placed on it.

An angle measuring device or transmitter 8 measures the current position or rotary position and/or rotary angle of the rotor 2 and therefore of the roller body 9 connected fixedly to the rotor 2 and can output the detected rotary position signals to the frequency control unit 5 which can output control signals or currents to the stator windings 3a, 3b, for example together with transmitters and/or control units of other rotation bodies or rollers, such that a number of rollers can be synchronised.

FIG. 2 shows an alternative embodiment of the rotation body 15′ including an axially movable external rotor motor, on which a roller body 9 as shown in FIG. 1 is placed. The bearings 6a for pivoting the rotor 2 on the stator 1 are movable in the axial direction of the stator 1 or connected to the stator 1 and enable the rotor 2 to move axially relative to the stator 1, wherein the permanent magnets 7a attached to the inner side of the rotor 2 extend further in the axial direction and/or are provided over a greater length than the length of the stator winding 3a in the axial direction, enabling a substantially identical magnetic field to be generated by the permanent magnets 7a connected to the rotor 2, even when the rotor 2 is moved axially relative to the stator 1 within a predefined range, in order to exert a driving or decelerating force on the rotor 2 in conjunction with the electromagnetic field generated by the stator windings 3a when a current flows through them.

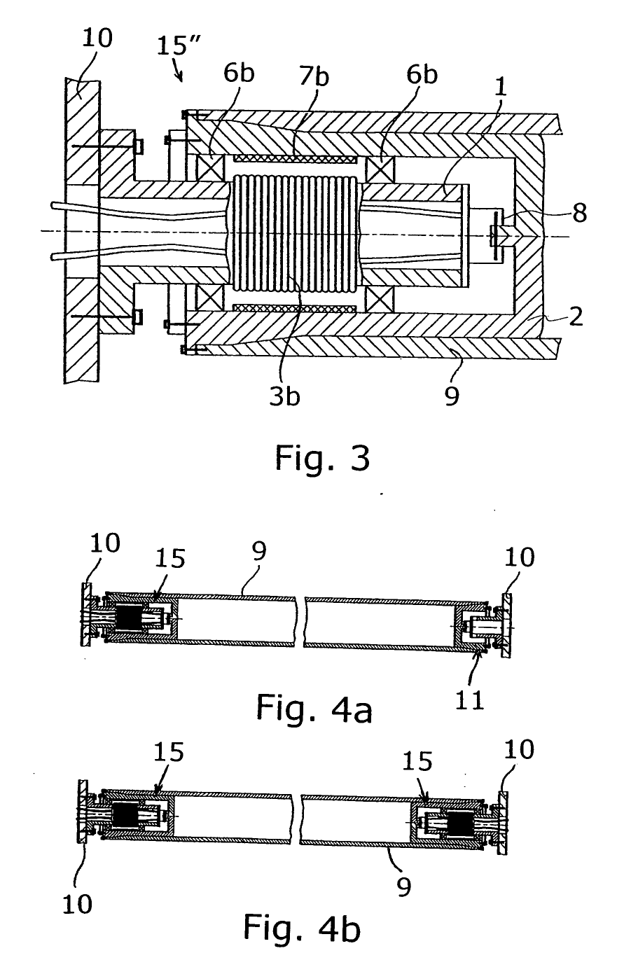

FIG. 3 shows another embodiment of a rotation body 15″ in accordance with the invention, comprising ball bearings 6b which do not enable the rotor 2 to move axially relative to the stator 1. The radial extent and/or length of the permanent magnets 7b in the radial direction can thus approximately correspond to the length of the stator winding 3b in the radial direction, without leading to a significant change in the magnetic coupling between the permanent magnets 7b and the stator winding 3b, necessary for generating a rotation or rotary force, during the operation of the external rotor motor.

FIG. 4a shows an embodiment of a roller driven by an external rotor motor or a driven cylinder 9, wherein on only one side of the roller or cylinder 9—the left-hand side in FIG. 4a—a rotation body 15 with an external rotor motor as described above is introduced, for example only laterally, into the roller or the cylinder 9, and the roller or cylinder 9 is supported at the opposing end by a conventional shaft journal 11. The motor schematically shown in FIG. 4a can for example be introduced into the roller or the cylinder only laterally, or can extend across larger areas of the axial length of the roller or cylinder 9, such as for example up to half the axial length, beyond half the axial length or even over the entire axial length of the roller or cylinder 9.

FIG. 4b shows another embodiment, wherein contrary to the example shown in FIG. 4a, a rotation body 15 with an external rotor motor as described above is provided at both ends of the roller or cylinder 9.

The motor shown in FIGS. 4a and 4b can generally be any of the motors described with reference to FIGS. 1 to 3.

1-16. (canceled)

17. A rotation body for a printing machine, comprising:
a stator including at least one stator winding; and
a rotor including at least one permanent magnet and positioned for rotation relative to the stator
wherein current flowing through the stator winding interacts with the at least one permanent magnet and generates a torque acting on the rotor.

18. The rotation body according to claim 17, wherein at least two stator windings are provided at axially offset points on the stator.

19. The rotation body according to claim 17, wherein the at least one stator winding generates a magnetic field for driving the rotor over at least half of an axial length of the rotor.

20. The rotation body according to claim 17, wherein the at least one stator winding is distributed over approximately an entire axial length of the stator.

21. The rotation body according to claim 17, wherein the at least one stator winding is provided on an outer surface of the stator.

22. The rotation body according to claim 17, wherein the rotor is a cylinder shell.

23. The rotation body according to claim 17, wherein the rotor is a cylinder body comprising a blind hole.

24. The rotation body according to claim 17, wherein the rotor is mounted on the stator by at least one bearing extending between the rotor and the stator, at least one bearing extending between the rotor and an external retainer, or at least a first bearing extending between the rotor and the stator and at least a second bearing extending between the rotor and the external retainer.

25. The rotation body according to claim 17, further comprising a cylinder body or roller body which is supported on the rotor and fixed thereto by a non-positive frictional lock, a positive lock or by a combination of a non-positive frictional lock and a positive lock.

26. The rotation body according to claim 17, further comprising a cooling system for cooling at least a partial area of the stator.

27. The rotation body according to claim 17, wherein the at least one permanent magnet is annular, rod-shaped or a combination of annular and-rod shaped.

28. The rotation body according to claim 17, wherein the at least one permanent magnet is provided on a rotor casing inner surface.

29. The rotation body according to claim 17, wherein the rotor supports or defines a deflecting cylinder, a drawing roller, a ductor, a central cylinder, a steel cylinder, a printing blanket cylinder, a form cylinder, a plate cylinder, a rubber cylinder, a knife cylinder, a collecting cylinder, a cutting cylinder, an inking roller, or dampening roller.

30. The rotation body according to claim 17, wherein the rotor is used in a folding apparatus or in a reel changer.

31. A printing machine drive comprising a rotation body according to claim 17.

32. The printing machine drive according to claim 31, further comprising a control device configured to one or more of a voltage, a strength of a current and a frequency of a current flowing in the at least one stator winding.

33. The printing machine drive according to claim 31, further comprising an angle sensor for measuring a rotary position of the rotor.

34. A rotation printing machine comprising rubber blanket cylinders and counter printing cylinders that together form printing points, and further comprising plate cylinders which are mechanically coupled in pairs with the rubber blanket cylinders into cylinder groupings, wherein each cylinder grouping is driven by one or more of the plate cylinder, rubber blanket cylinder or the counter printing cylinder including a rotation body according to claim 17.

35. The rotation body according to claim 17 wherein the rotation body defines a bearing for a cylinder or a roller of a printing machine.

36. A method of driving a cylinder or roller of a printing machine, the method comprising:
providing at least one rotation body comprising:
a stator supported by the printing machine and including at least one stator winding; and
a rotor including at least one permanent magnet and positioned for rotation relative to the stator;
positioning the cylinder or roller about the rotor; and
selectively providing current through the stator winding.
